(19) United States
(12) Patent Application Publication
(10) Pub. No.: US 2005/0258194 A1
(43) Pub. Date: Nov. 24, 2005

(54) Caulking gun having a detachable extendable handle

(76) Inventor: Robert W. Abbott, Grants Pass, OR (US)

Correspondence Address: JOSEPH P. CURTIN, 1469 N.W. MORGAN LANE, PORTLAND, OR, 97229, US

(21) Appl. No.: 10/848,281

(22) Filed: May 18, 2004

(51) Int. Cl. G01F 11/06

(52) U.S. Cl. 222/326

(57) ABSTRACT

A caulking gun having a body, a grip actuator and a cable member allows caulk or like material to be applied to a surface that is located a distance from a workman. The body includes a handle and an actuator lever, and receives a container having a material that is applied to a selected surface when the actuator lever is actuated. The cable member is coupled between the grip actuator and the actuator lever, and causes the actuator lever to be actuated when the grip actuator is actuated. The caulking gun can further includes an extension handle having a grip end and a coupling end. The coupling end of the extension handle is coupled to the handle and the grip actuator is attached to the grip end. The extension handle can have a variable length and can be detachably coupled to the handle.

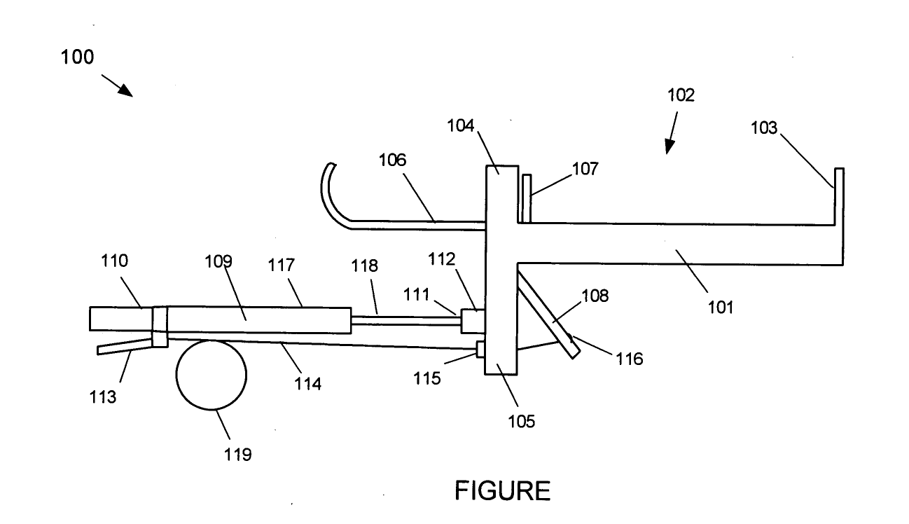

### BACKGROUND OF THE INVENTION

1. Field of the Invention

The present invention relates to a dispensing device. More particularly, the present invention relates to a dispensing device capable of applying caulk and like material to a surface located near to and at a distance from a workman.

2. Description of the Related Art

It is known to provide a caulking gun with an elongated extension handle, thereby enabling operation of the gun to apply caulk or like material to a surface that is at a distance from a workman, such as overhead or near to the ground. For example, U.S. Pat. No. 4,932,565 to Paradiso, U.S. Pat. No. 4,979,649 to Wescott and U.S. Pat. No. 6,220,485 to Chang each disclose a conventional caulking gun having an extension handle.

Nevertheless, while such conventional caulking guns enable application of caulk or like material to a surface located a distance from a workman, a caulking gun that does not have an extension handle is required for conveniently applying caulk to a surface that is located near to a workman. Consequently, two caulking guns are required so that caulking or the like can be applied to surfaces that are both near to and at a distance from a workman.

Consequently, what is needed is caulking gun having a detachable, extendable handle. Moreover, what is needed is a caulking gun having a variable-length and detachable extendable handle.

### BRIEF SUMMARY OF THE INVENTION

The present invention provides a caulking gun having a detachable, extendable handle. Additionally, the present invention provides a caulking gun having a variable-length and detachable extendable handle.

A first embodiment of the present invention provides a caulking gun having a body, a grip actuator and a cable member. The body includes a handle and an actuator lever, and receives a container having a material that is applied to a selected surface when the actuator lever is actuated. The cable member is coupled between the grip actuator and the actuator lever, and causes the actuator lever to be actuated when the grip actuator is actuated. The first embodiment of the present invention can further include an extension handle having a grip end and a coupling end. The coupling end is coupled to the handle and the grip actuator is attached to the grip end. In an alternative configuration of the first embodiment of the present invention, the extension handle has a variable length. In yet another alternative configuration of the first embodiment of the present invention, the extension handle is detachably coupled to the handle.

A second embodiment of the present invention provides a caulking gun having a body and a variable-length extension handle. The body includes a handle and an actuator lever, and receives a container having a material that is applied to a selected surface when the actuator lever is actuated. The extension handle has a grip end and a coupling end that is coupled to the handle. A grip actuator is attached to the grip end of the extension handle, and a cable member is coupled between the grip actuator and the actuator lever. The cable member causes the actuator lever to be actuated when the grip actuator is actuated.

A third embodiment of the present invention provides a caulking gun having a body and an extension handle. The body includes a handle and an actuator lever, and receives a container having a material that is applied to a selected surface when the actuator lever is actuated. The extension handle includes a grip end and a coupling end that is detachably coupled to the handle. A grip actuator is attached to the grip end of the extension handle, and a cable member is coupled between the grip actuator and the actuator lever. The cable member causes the actuator lever to be actuated when the grip actuator is actuated.

### BRIEF DESCRIPTION OF THE DRAWING

The present invention is illustrated by way of example and not by limitation in the sole accompanying FIGURE that shows a caulking gun having a detachable, extendable handle according to the present invention.

### DETAILED DESCRIPTION OF THE INVENTION

In the following description, as well as in the claims, the expression “caulking gun” means a device that receives cartridges containing many different types of materials, such as caulk, glue, sealant and the like, and dispenses the contents of the cartridge onto a surface, as is commonly used and understood by workmen, suppliers, etc.

The sole FIGURE shows a caulking gun 100 having a detachable, extendable handle according to the present invention. Caulking gun 100 includes a body 101 having a semi-circular cross section breech portion 102 that is adapted to receive a cartridge (not shown) containing, for example, caulk, glue, sealant or the like. Caulking gun 100 includes a fixed front end 103 and a fixed rear end 104. Front end 103 includes a central opening (not shown) through which a nozzle (not shown) of a cartridge protrudes. A handle 105 extends from body 101. A shaft 106 and plunger 107 are mechanically coupled to a actuator lever 108 in a well-known manner so that as actuator lever 108 is squeezed toward handle 105, shaft 106 and plunger 107 are urged toward front end 103, thereby dispensing material contained in a cartridge.

Caulking gun 100 also includes an extension handle 109 that has a grip end 110 and a coupling end 111. Extension handle 109 allows caulking gun 100 to be used to apply caulk or like material to a selected surface that is located a distance from a workman. Coupling end 111 detachably fastens to a coupler 112 that is part of handle 105. That is, coupling end 111 is conveniently detachable from coupler 112. For example, coupling end 111 can be threaded and mates with coupler 112, which is also threaded in a complementary manner. Alternatively, coupling end 111 can be spring loaded into coupler 112 so that when coupling end 111 is inserted into coupler 112, a spring mechanism fastens coupling end 111 into coupler 112 in a well-known manner. As yet another alternative configuration, coupling end 111 can press fit into coupler 112. Extension handle 109 is then released from handle 105 by pulling coupling end 111 out of coupler 112.

Grip actuator 113 is attached to extension handle 109 at grip end 110. A jacketed cable 114 is connected between grip actuator 113 and actuator lever 108. Cable 114 passes through a cable guide 115 in handle 105 and attaches to actuator trigger 108 at cable quick release 116. Cable 114 is jacketed, that is, cable 114 is a cable within an outer jacket housing, between grip actuator 113 and cable guide 115 so that when grip actuator 113 is squeezed toward grip end 110, the relative movement of cable 114 within the jacket causes actuator lever 108 to be urged toward handle 105, in a manner similar to the operation of a bicycle hand brake. Simultaneously, as grip actuator 113 is squeezed toward grip end 110, shaft 106 and plunger 107 are urged toward front end 103, thereby dispensing material contained in a cartridge.

Thus, the basic exemplary configuration of the present invention is a caulking gun having a grip actuator 113 and a cable 114 coupling grip actuator 114 to actuator lever 108 of the caulking gun. That is, basic exemplary configuration of the present invention is the exemplary configuration shown in the sole FIGURE without extension handle 109. Many workmen already have at least one extension handle available for use with other tools, such as paint rollers, paint brushes and squeegees, that can also be used as an extension handle for the basic configuration of the present invention. Extension handle 109 is conveniently attached to coupler 112 and cable 114 to cable quick release 116 so that a workman can apply caulk or like material to a surface that is a distance from the workman. When caulk or like material is to be applied to a surface that is close proximity of a workman, cable 114 can be conveniently disconnected from cable quick release 116 and extension handle 109 can be conveniently uncoupled from coupler 112.

Preferably, extension handle 109 is a telescoping extension handle, as represented by telescoping sections 117 and 118, so that the overall length of extension handle 109 can be varied as needed. While only two telescoping sections 117 and 118 are shown, it should be understood that extension handle 109 can have more than two telescoping sections. Cable 114 is shown looped at 119 to accommodate the variable overall length of extension handle 109. Alternatively, extension handle 109 can be a fixed length, in which case cable 114 will not need to accommodate variable lengths of extension handle 109.

As an alternative embodiment of the present invention, extension handle 109 can be fixed to handle 105 and be telescoping, thereby providing a variable length extension handle.

Although the foregoing invention has been described in some detail for purposes of clarity of understanding, it will be apparent that certain changes and modifications may be practiced that are within the scope of the appended claims. Accordingly, the present embodiments are to be considered as illustrative and not restrictive, and the invention is not to be limited to the details given herein, but may be modified within the scope and equivalents of the appended claims.

1. A caulking gun, comprising:
a body having a handle and an actuator lever, the body receiving a container having a material that is applied to a selected surface when the actuator lever is actuated;
a grip actuator; and
a cable member coupled between the grip actuator and the actuator lever, the cable member causing the actuator lever to be actuated when the grip actuator is actuated.

2. The caulking gun according to claim 2, further comprising an extension handle having a grip end and a coupling end, the coupling end being coupled to the handle and the grip actuator being attached to the grip end.

3. The caulking gun according to claim 2, wherein the coupling end of the extension handle is detachably coupled to the handle.

4. The caulking gun according to claim 2, wherein the extension handle has a variable length.

5. A caulking gun, comprising:
a body having a handle and an actuator lever, the body receiving a container having a material that is applied to a selected surface when the actuator lever is actuated;
an extension handle having a grip end and a coupling end that is coupled to the handle, the extension handle having a variable length;
a grip actuator attached to the grip end of the extension handle; and
a cable member coupled between the grip actuator and the actuator lever, the cable member causing the actuator lever to be actuated when the grip actuator is actuated.

6. The caulking gun according to claim 5, wherein the coupling end of the extension handle is detachably coupled to the handle.

7. A caulking gun, comprising:
a body having a handle and an actuator lever, the body receiving a container having a material that is applied to a selected surface when the actuator lever is actuated;
an extension handle having a grip end and a coupling end that is detachably coupled to the handle;
a grip actuator attached to the grip end of the extension handle; and
a cable member coupled between the grip actuator and the actuator lever, the cable member causing the actuator lever to be actuated when the grip actuator is actuated.
